(19) United States
(12) Patent Application Publication
(10) Pub. No.: US 2018/0060888 A1
(43) Pub. Date: Mar. 1, 2018

(54) EROSION RATE PREDICTION POST LOSS OF EXCLUSIVITY

(71) Applicant: INTERNATIONAL BUSINESS MACHINES CORPORATION, Armonk, NY (US)

(72) Inventors: Parul ARORA, New York, NY (US); Raphael EZRY, New York, NY (US); Munish GOYAL, Yorktown Heights, NY (US); Sergio R. ZAMBRANO, Charlotte, NC (US)

(21) Appl. No.: 15/251,424

(22) Filed: Aug. 30, 2016

(51) Int. Cl. G06Q 30/02

(52) U.S. Cl. CPC G06Q 30/0203; G06Q 30/0201

(57) ABSTRACT

Methods, computer program products, and systems are presented. The methods include, for instance: obtaining input data regarding to a market for a branded product subject to loss of exclusivity scheduled. A dynamic half-life of a market value for the branded product is estimated to predict a market share erosion rate of the branded product at a point of time after the loss of exclusivity.

### TECHNICAL FIELD

The present disclosure relates to predictive modeling and analytics, and more particularly to methods, computer program products, and systems for predicting the pace of market share erosion after loss of exclusivity.

### BACKGROUND

In conventional market share analysis of a specific group of products behaving similarly, numerous factors may influence changes in and paces of market share of one of the products. Taking the influencing factors into account accurately in formulating a predictive model of market share is of critical importance as accurate prediction will contribute greatly to business planning including inventory management, sales and marketing strategy design, even a new scheme on product line-up.

### SUMMARY

The shortcomings of the prior art are overcome, and additional advantages are provided, through the provision, in one aspect, of a method. The method for predicting a market share erosion rate of a branded product after loss of exclusivity includes, for example: obtaining, by one or more processor of a computer, input data including respective financial data of each player in a market of the branded product, payer policies, and cost of production for the branded product; calculating and recording the market share erosion rate of the branded product at a point of time after loss of exclusivity, by use of a dynamic half-life of a market value of the branded product at the point of time; and producing recorded data including the market share erosion rate to a user for further use.

Additional features are realized through the techniques set forth herein. Other embodiments and aspects, including but not limited to computer program product and system, are described in detail herein and are considered a part of the claimed invention.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 depicts a system for predicting post-loss of exclusivity (LOE) erosion of market share, in accordance with one or more embodiments set forth herein;

FIG. 2 depicts a data flow of the system of FIG. 1, particularly the data flow within the post-LoE erosion prediction engine, in accordance with one or more embodiments set forth herein;

FIG. 3 depicts a flowchart for the post-Loss of Exclusivity (LoE) erosion prediction engine 130 of FIG. 1, in accordance with one or more embodiments set forth herein;

FIG. 4 depicts formulae utilized in predictions of the post-Loss of Exclusivity (LoE) erosion prediction engine 130 of FIG. 1 as used in respective blocks of the flowchart of FIG. 3, in accordance with one or more embodiments set forth herein;

FIGS. 5A and 5B depict respective relationships between events, dynamic half-life L(t), and a market share for a branded product A, in accordance with one or more embodiments set forth herein;

FIG. 6 depicts a cloud computing node according to an embodiment of the present invention;

FIG. 7 depicts a cloud computing environment according to an embodiment of the present invention; and

FIG. 8 depicts abstraction model layers according to an embodiment of the present invention.

### DETAILED DESCRIPTION

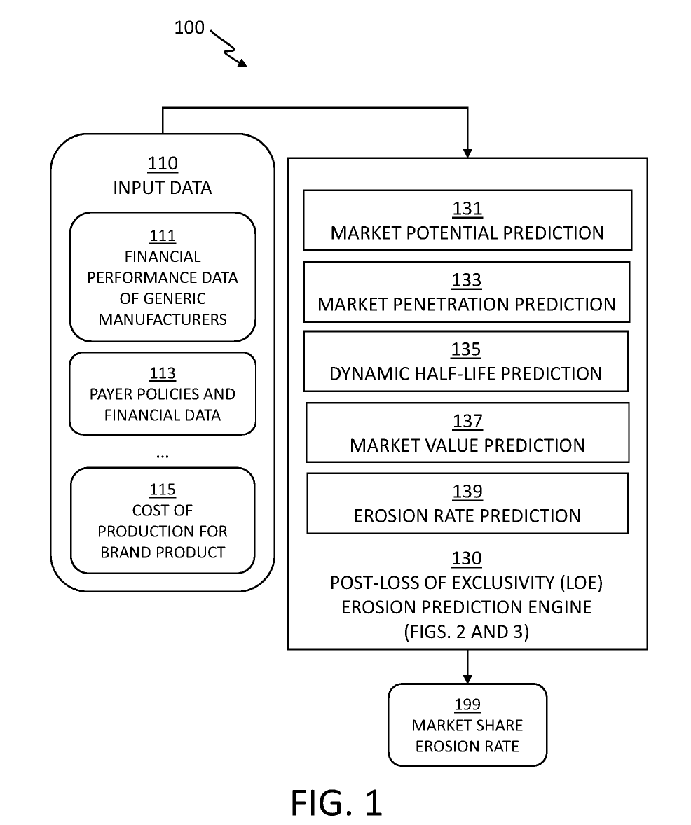

FIG. 1 depicts a system 100 for predicting post-loss of exclusivity (LOE) erosion of market share, in accordance with one or more embodiments set forth herein.

The system 100 for predicting post-LoE erosion on market share of a branded product includes a post-Loss of Exclusivity (LoE) erosion prediction engine 130 that takes input data 110 and creates a market share erosion rate 199. The input data 110 includes financial performance data of generic manufacturers 111, payer policies and financial data 113, and cost of production for brand product 115.

A market for a branded product is distinguished from other market by purposes of the product and other conditions specific to the market. For example, a branded drug market is distinguished by a medical condition/disease for which the branded drug is used. Within the market, one or more distinctive medicinal chemical composition may co-exist, based on how to treat a common medical condition. The branded drug may be granted exclusivity in the market for a period of time by a government agency, during which the branded drug enjoys the exclusive market. After the exclusivity is lost, other branded drug or a generic drug may enter the market. As pharmaceutical industry is heavily regulated and there are many players other than manufacturers influencing markets, a post-LoE market erosion rate of a drug may vary depending on the type of the drug and a medical condition for which the drug is used for, demographic information of target patients as well as numerous events influencing the market as certain players takes actions. Examples of the events influencing the markets may be changes in government regulations and policies of the pharmaceutical market, price control, changes in payment programs by health insurance, etc. As branded drugs having enormous amount of annual sales are to lose the exclusivity sooner or later, the market share erosion analysis and accurate prediction is of critical importance to pharmaceutical industry. The embodiments of the present invention is applicable to similar markets for products having characteristics of exclusivity and market influencing events.

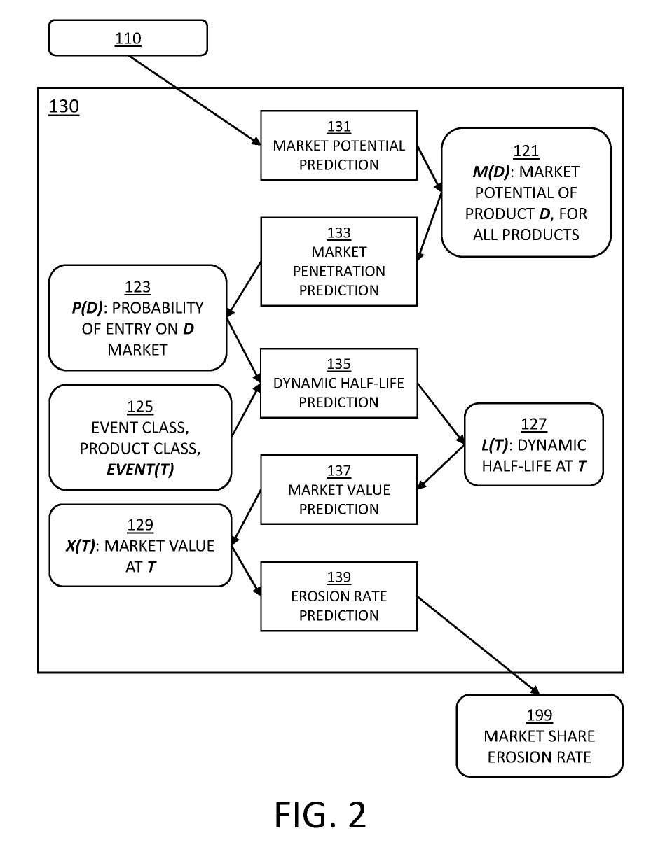

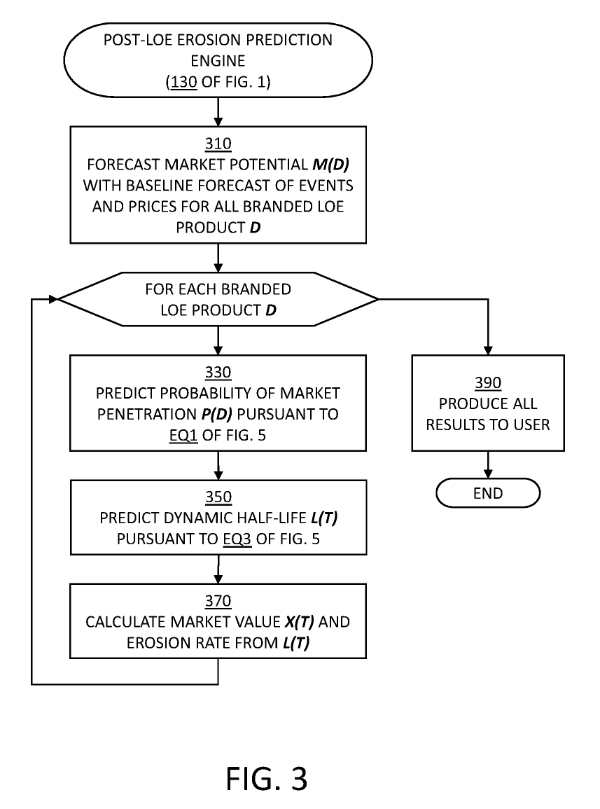

The post-LoE erosion prediction engine 130 includes processes of a market potential prediction 131, a market penetration prediction 133, a dynamic half-life prediction 135, a market value prediction 137, and an erosion rate prediction 139. A process performing the market potential prediction 131 estimates how a size of the market, that is a future market value, would be based on relevant element of the input data 110. The market penetration prediction 133 estimates how likely other branded or generic manufacturer would enter the market. The dynamic half-life prediction 135 estimates how long it would take for a market value of the branded product to be reduced to a half of the market value, which varies depending on more than one factor, particularly events influencing the market. The market value prediction 137 estimates how much the market value of the branded product would be at a point of time in the future after the LoE based on the predicted half-life of the branded product. The erosion rate prediction 139 estimates a pace of market erosion for the branded product at a point of time in the future, based on the market value as predicted. Details of respective processes of the post-LoE erosion prediction engine 130 are presented in FIGS. 2 and 3 and corresponding descriptions.

Examples of the events influencing the market share erosion may be, but not limited to, health and safety policies of government and payment policies of insurance providers such as promoting cheaper generic drugs when available over more expensive branded drugs, stage of development of generic drugs by multiple generic manufacturers, disease-specific safety and efficacy concerns of respective drugs based on franchises and therapeutic classes of the drugs as published in authoritative publications and/or news articles, preferences of prescribing physicians as well as social network effects on choices by patients, a market structure determining price cap/floors for certain types of drugs, responses to the market events by wholesalers and by retail pharmacies, other branded drugs in a development/production pipeline of a manufacturer.

Based on the post-LoE erosion prediction, a manufacturer of a branded product may decide what to do for the branded product and/or for the franchise that manufactures one or more branded products, such as transition to a product line of more difficulty in manufacturing to prevent competition, aggressive marketing and significant price reduction for a wholesaler to dominate inventory of the wholesaler, etc.

FIG. 2 depicts a data flow of the system 100 of FIG. 1, particularly the data flow within the post-LoE erosion prediction engine 130, in accordance with one or more embodiments set forth herein.

The input data 110 to the post-Loss of Exclusivity (LoE) erosion prediction engine 130 is first provided to the market potential prediction process 131 to generate a market potential M 121 for a specific branded LoE product D. The market potential M 121 is utilized as an input for the market penetration prediction process 133, which generates a probability P(D) 123 of other products to enter a market of the product D. The dynamic half-life prediction process 135 generates a dynamic half-life at time t, represented by L(t) 127, based on the probability P(D) 123 and an event class, an event variable EVENT(t), and a product class 125, which are formulated based on the characteristics of the product D. The event variable EVENT(t) is a binary variable set as one (1) if a type of event in the event class occurs, or as zero (0) if a type of event in the event class does not occur. By use of the dynamic half-life L(t) 127, the market value prediction process 137 generates an estimated market value at time t, represented by X(7) 129, and the erosion rate prediction process 138 predicts the market share erosion rate 199 at time t based on the market value X(t) 129.

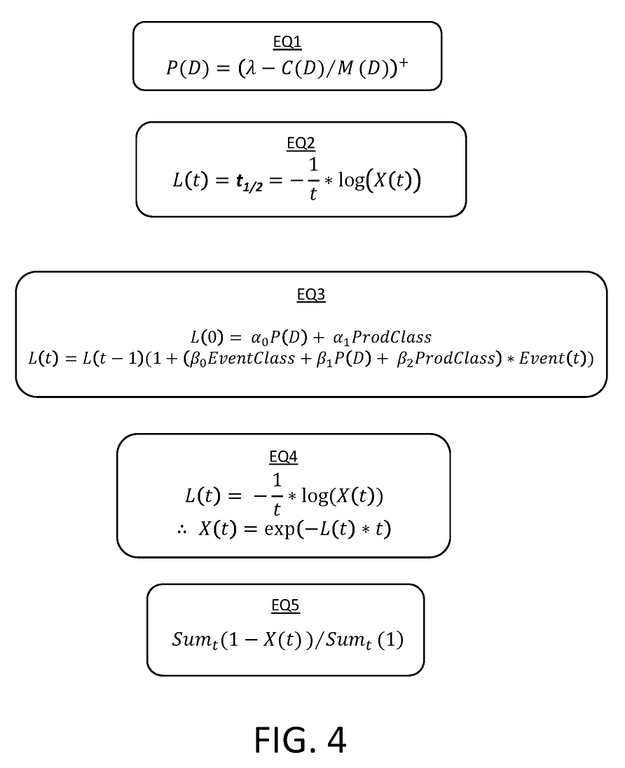

FIG. 3 depicts a flowchart for the post-Loss of Exclusivity (LoE) erosion prediction engine 130 of FIG. 1, in accordance with one or more embodiments set forth herein. FIG. 4 depicts formulae utilized in predictions of the post-Loss of Exclusivity (LoE) erosion prediction engine 130 of FIG. 1 as used in respective blocks of the flowchart of FIG. 3, in accordance with one or more embodiments set forth herein.

In block 310, the post-LoE erosion prediction engine 130 respective market potential M(D) of each branded product D for all branded products. The respective market potential M(D) is estimated by use of a baseline forecast of net sales of the branded product D in the future. In this specification, terms “market potential”, “market size”, and “net sales” are used interchangeably. In the baseline forecast, changes in sales prices and impacts of market events such as launches of other branded products are taken into account. Event types may be further profiled and categorized into some event classes. Then post-LoE erosion prediction engine 130 proceeds with block 330.

For each branded product D that is subject to Loss of Exclusivity (LoE), the post-LoE erosion prediction engine 130 respectively performs a series of predictions as shown in FIG. 2, in corresponding blocks 330, 350, and 370. After respective erosion rates are generated for all branded products, the post-LoE erosion prediction engine 130 proceeds with block 390, in which produces results from blocks 310, 330, 350, and 370 for each branded product D to a user.

In block 330, the post-LoE erosion prediction engine 130 estimates a probability of market penetration P(D) on the market of the branded product D by use of the input data including the financial performance data of generic manufacturers and cost of production for brand product, and the predicted market potential M(D) from block 310. The probability P(D) is estimated according to Formula EQ1 of FIG. 4, wherein λ is an estimated optimal water filling level for all branded products based on the market condition, C(P) is a cost of production for the branded product D, and M(D) is the market potential of the branded product D as estimated in block 301. The optimal water filling level λ determines a threshold for profitability in producing a product from a portfolio of products, provided financial constraints, competition, and respective market values of each product. According to Formula EQ1 of FIG. 4, the probability P(D) is determined as (λ−C(D)/M(D))⁺, indicating that P(D) is determined as a value that may keep the difference between the optimal water level (λ) and the cost-market potential ratio (C(D)/M(D)) as a positive (+) value, which means if a production of the product may be profitable as quantified by (λ−C(D)/M(D)) for the product D considering the cost of production and the market potential of the product D. The probability P(D) for the product D is calculated as the profit margin of the product D in proportion to the sum of all profit margins of all products in the portfolio. Then post-LoE erosion prediction engine 130 proceeds with block 350.

In block 350, the post-LoE erosion prediction engine 130 estimates a dynamic half-life L(t) for the market value of the branded product D at time t months after the Loss of Exclusivity. Formula EQ2 of FIG. 4 is a conventional half-life equation, abbreviated as t_{1/2}, which defines the half-life L(t) as a period of time during which the market value X(t) of the branded product D is reduced in one-half of the original market value, at time t months after the LoE. The dynamic half-life L(t) at time t months after the LoE is also formulated according to Formula EQ3 of FIG. 4, referred to as a dynamic half-life formula, L(0)=α₀P(D)+α₁DrugClass, L(t)=L(t−1)(1+(β₀EventClass+β₁P(D)+β₂DrugClass)*Event(t)), wherein L(0) is an initial half-life based on a type of product, represented as ProdClass, and the probability of market penetration P(D) at the time of LoE, wherein L(t) is defined based on L(t−1) and EventClass, ProdClass, and the probability P(D) if Event(t)=1 (or True) indicating that a type of event in EventClass occurs, or L(t) is same as L(t−1) if Event(t)=0 (or False) indicating that the type of event in EventClass does not occur. All parameters, α₀, α₁, β₀, β₁, and β₂ in EQ3 of FIG. 4 are respectively set by use of an auto-regressive (AR) model to optimally factor in contributions of each component of EventClass, ProdClass, and the probability P(D) to the new instance of the dynamic half-life L(t). Accordingly, the dynamic half-life L(t) reflects dynamics of market events, product classes, and the probability of generic entry, as represented by respective components, into an adjusted half-life period, as opposed to a static half-life as fixed in the conventional half-life formula (t_{1/2}).

In one embodiment of the present invention, the pace of entry of new products into the market of the product D, represented as the half-life L(t), is influenced by various events including launches of other branded products, changes in government incentive for purchasing the branded product, and changes in the price of the branded product D. Accordingly, in block 350, the events are respectively predicted to occur at t months after LoE, and the dynamic half-life L(t) is estimated based on L(t−1). Then post-LoE erosion prediction engine 130 proceeds with block 370.

In block 370, the post-LoE erosion prediction engine 130 calculates the market value X(t) of the branded product D at time t months after the LoE, from the dynamic half-life L(t) as estimated from block 350, according to Formula EQ4 of FIG. 4. Further, based on the market value X(t), the erosion rate of the branded product D after t months since the LoE is calculated as Sumₜ(1−X(t))/Sumₜ(1) according to Formula EQ5 of FIG. 4. Then post-LoE erosion prediction engine 130 proceeds with block 390.

In block 390, the post-LoE erosion prediction engine 130 produces results from blocks 310, 330, 350, and 370 for each branded product D to a user, to be used for business/marking planning and strategies or further analysis and predictions. Then post-LoE erosion prediction engine 130 completes processing.

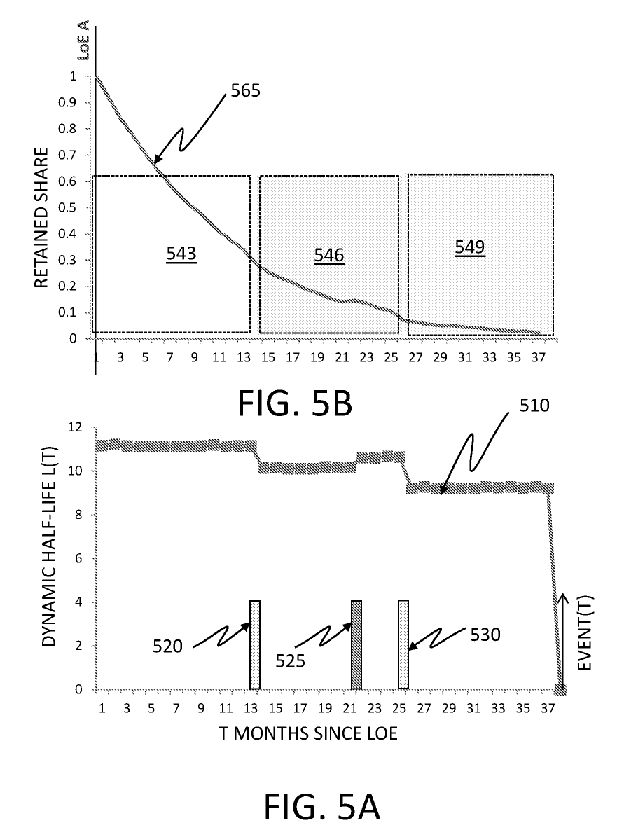

FIGS. 5A and 5B depict respective relationships between events, dynamic half-life L(t), and a market share for a branded product A, in accordance with one or more embodiments set forth herein.

FIG. 5A depicts a half-life graph 510 of a dynamic half-life L(t) of the branded product A, noted as a rectangle-dotted line on a x-y plane with x-axis t, indicating a number of months since LoE, and y-axis L(t), indicating the dynamic half-life of the branded product A at time t. On the right side, FIG. 5A also shows a second y-axis Event(t), indicating binary values corresponding to event occurrences at time t, with the common x-axis t, wherein the events 520, 525, and 530 are depicted in the same x-y plane. During the period between the time of LoE and a first event 520 at t=13, the dynamic half-life L(t) is consistent at approximately eleven (11), indicating that the market value of the product A at the time of LoE will be reduced to the half of its initial market value in eleven months. The first event 520 shortens the dynamic half-life L(t) and the new half-life as affected by the first event 520 is approximately ten (10), indicating that the market value of the product A at the time of the first event 520 will be reduced to half in ten months. A second event 525 at t=21 lengthens the dynamic half-life L(t) by a half month or so, thus the new half-life as affected by the second event 525 is approximately ten and a half (10.5), indicating that the market value of the product A at the time of the second event 525 will be reduced to half in ten and a half months. A third event 530 at t=25 shortens the dynamic half-life L(t) by a month, thus the new half-life as affected by the third event 530 is approximately nine and a half (9.5), indicating that the market value of the product A at the time of the third event 530 will be reduced to half in nine and a half months.

FIG. 5B depicts a market share graph 565 on another x-y plane with x-axis t, indicating a number of months since LoE scaled identical to the x-axis of FIG. 5A, and y-axis retained share, indicating a ratio of a market value at time t over a market value at the time of LoE, noted as X(t)/X(0). The areas 543, 546, and 549 represents respective time periods during which respective government policies are in effect.

The first event 520 and the third event 530 of FIG. 5A are in EventClass corresponding to government policy change. Other EventClass for the first event 520 and the third event 530 of FIG. 5A may be launches of new generic products in the market, a news report of quality concern on the product A, etc. The second event 525 of FIG. 5A may be a market boosting event for the product A such as a safety concern for a competitor product, a new-found effect of the product A, new incentives for purchasing the product A, etc. According to the market share prediction as shown in FIG. 5B, the product A would lose approximately seventy-three percent (73%) of the market share within thirty-six (36) months from the Loss of Exclusivity. The product A may be in a specific ProdClass, which may behave distinctively from other product classes.

Certain embodiments of the present invention may offer various technical advantages, including optimized modeling of market share half-life by evaluating an optimal water filling levels for a portfolio including numerous pharmaceutical products, by computing probability of a new market entry, and by predicting the half-life that is dynamically responding to events in the market. The same embodiments further efficiently predict future market events and their influence to the market share erosion, based on specific product classes, event classes and past occurrences of the events simulated by use of historical market and financial data of market players. Accordingly, the same embodiments of the present invention greatly improve ability to forecast market trend post-Loss of Exclusivity for a branded product and contribute greatly in further analysis of market trend and establishment of business/marketing strategy encompassing various actions to maximize revenue. Certain embodiments of the present invention may be offered as a fee-based service on a cloud infrastructure.

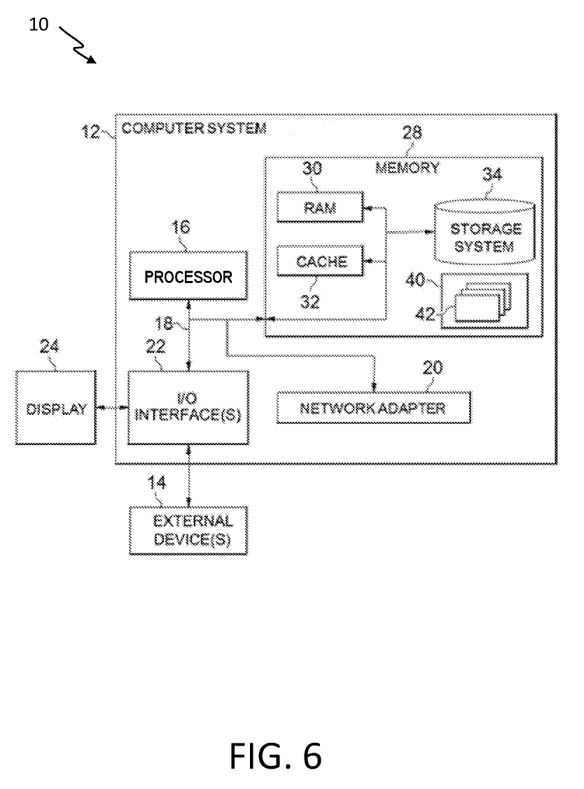

FIGS. 6-8 depict various aspects of computing, including a computer system and cloud computing, in accordance with one or more aspects set forth herein.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 6, a schematic of an example of a computer system/cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system 12, which is operational with numerous other general purpose or special purpose computing system environments or configurations. Examples of well-known computing systems, environments, and/or configurations that may be suitable for use with computer system 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system 12 may be described in the general context of computer system-executable instructions, such as program processes, being executed by a computer system. Generally, program processes may include routines, programs, objects, components, logic, data structures, and so on that perform particular tasks or implement particular abstract data types. Computer system 12 may be practiced in distributed cloud computing environments where tasks are performed by remote processing devices that are linked through a communications network. In a distributed cloud computing environment, program processes may be located in both local and remote computer system storage media including memory storage devices.

As shown in FIG. 6, computer system 12 in cloud computing node 10 is shown in the form of a general-purpose computing device. The components of computer system 12 may include, but are not limited to, one or more processors 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system 12 typically includes a variety of computer system readable media. Such media may be any available media that is accessible by computer system 12, and it includes both volatile and non-volatile media, removable and non-removable media.

System memory 28 can include computer system readable media in the form of volatile memory, such as random access memory (RAM) 30 and/or cache memory 32. Computer system 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program processes that are configured to carry out the functions of embodiments of the invention.

One or more program 40, having a set (at least one) of program processes 42, may be stored in memory 28 by way of example, and not limitation, as well as an operating system, one or more application programs, other program processes, and program data. Each of the operating system, one or more application programs, other program processes, and program data or some combination thereof, may include an implementation of the post-Loss of Exclusivity (LoE) erosion prediction engine 130 of FIG. 1. Program processes 42, as in the flowchart of FIG. 3, describing processes of the post-LoE erosion prediction engine 130, generally carry out the functions and/or methodologies of embodiments of the invention as described herein.

Computer system 12 may also communicate with one or more external devices 14 such as a keyboard, a pointing device, a display 24, etc.; one or more devices that enable a user to interact with computer system 12; and/or any devices (e.g., network card, modem, etc.) that enable computer system 12 to communicate with one or more other computing devices. Such communication can occur via Input/Output (I/O) interfaces 22. Still yet, computer system 12 can communicate with one or more networks such as a local area network (LAN), a general wide area network (WAN), and/or a public network (e.g., the Internet) via network adapter 20. As depicted, network adapter 20 communicates with the other components of computer system 12 via bus 18. It should be understood that although not shown, other hardware and/or software components could be used in conjunction with computer system 12. Examples, include, but are not limited to: microcode, device drivers, redundant processing units, external disk drive arrays, RAID systems, tape drives, and data archival storage systems, etc.

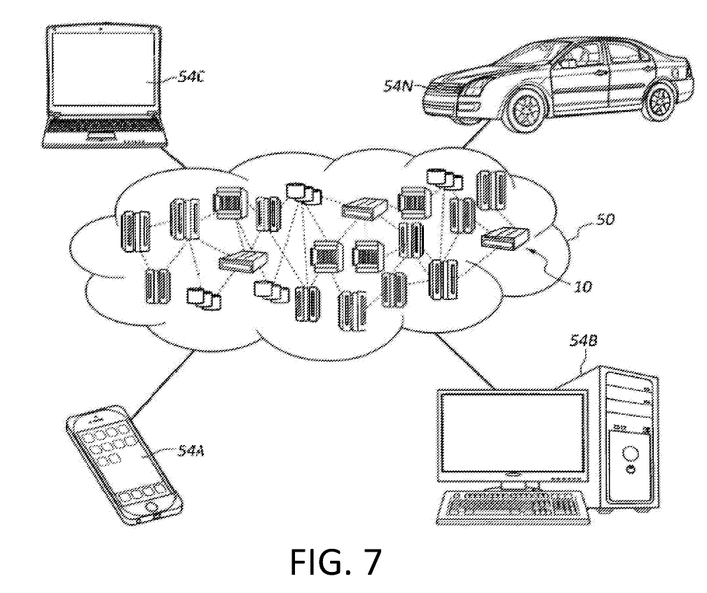

Referring now to FIG. 7, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 running one or more instances of the post-LoE erosion prediction engine 130 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 7 are intended to be illustrative only and that computing nodes 10 and cloud computing environment 50 can communicate with any type of computerized device over any type of network and/or network addressable connection (e.g., using a web browser).

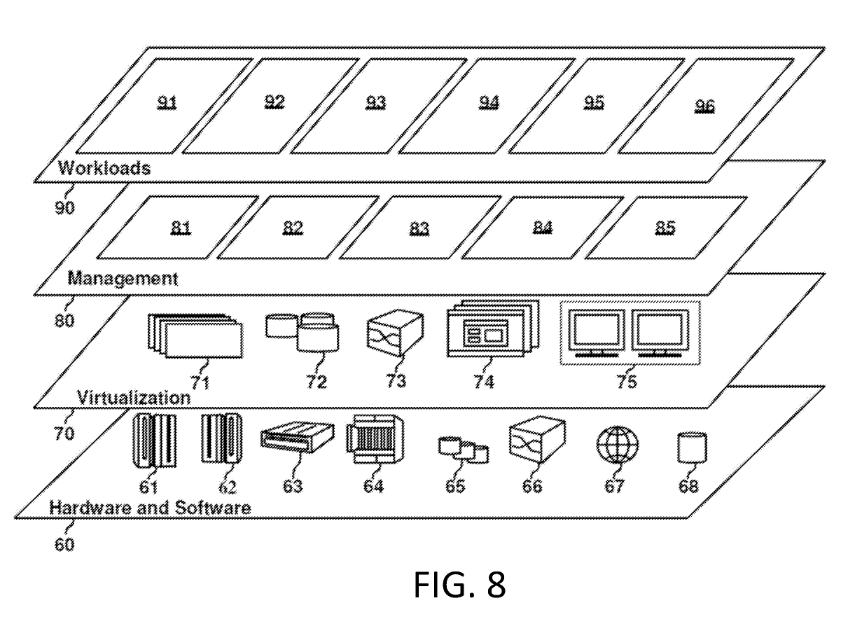

Referring now to FIG. 8, a set of functional abstraction layers provided by cloud computing environment 50 (FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and processing components for the lighthouse server 96, as described herein. The processing components 96 can be understood as one or more program 40 described in FIG. 6.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description set forth herein has been presented for purposes of illustration and description, but is not intended to be exhaustive or limited to the form disclosed. Many modifications and variations will be apparent to those of ordinary skill in the art without departing from the scope and spirit of the disclosure. The embodiment was chosen and described in order to best explain the principles of one or more aspects set forth herein and the practical application, and to enable others of ordinary skill in the art to understand one or more aspects as described herein for various embodiments with various modifications as are suited to the particular use contemplated.

What is claimed is:

1. A computer implemented method for predicting a market share erosion rate of a branded product after loss of exclusivity, comprising:
obtaining, by one or more processor of a computer, input data including respective financial data of each player in a market of the branded product, payer policies, and cost of production for the branded product;
calculating and recording the market share erosion rate of the branded product at a point of time after loss of exclusivity, by use of a dynamic half-life of a market value of the branded product at the point of time; and
producing recorded data including the market share erosion rate to a user for further use.

2. The computer implemented method of claim 1, the calculating the market share erosion rate comprising:
calculating and recording the market value at the point of time by reducing a first dynamic half-life of the market value estimated by a dynamic half-life formula to the market value by use of a conventional half-life formula t_{1/2}; and
calculating and recording the market share erosion rate as a ratio of respective lost market value over the initial market value cumulated up to the point of time as estimated on every time unit.

3. The computer implemented method of claim 2, wherein the first dynamic half-life is adjusted, upon an occurrence of an event at one point of time, based on a dynamic half-life at a previous point of time and a combination of a type of the event, a probability for a generic product entering the market of the branded product, and a type of the branded product, such that the dynamic half-life accurately reflects influence of the event for the type of the branded product on changes of the market value.

4. The computer implemented method of claim 3, wherein components of the dynamic half-life including the type of the event, the probability for the generic product entering the market of the branded product, and the type of the branded product are multiplied by respective parameters estimated by use of auto-regressive modeling.

5. The computer implemented method of claim 4, wherein the event and corresponding type of the event is predicted based on the input data and historic data of the market.

6. The computer implemented method of claim 5, wherein the probability for the generic product entering the market of the branded product is estimated by use of an optimal water filling level for all products in a portfolio to which the branded product belong, the cost of production for the branded product from the input date, and a market potential of the market of the branded product.

7. The computer implemented method of claim 6, wherein the market potential is estimated by use of the financial data from the input data, and wherein the optimal water filling level is determined as a threshold for profitability in producing a product from the portfolio with a market condition as provided in the input data.

8. A computer program product comprising:
a computer readable storage medium readable by one or more processor and storing instructions for execution by the one or more processor for performing a method for predicting a market share erosion rate of a branded product after loss of exclusivity, comprising:
obtaining, by the one or more processor, input data including respective financial data of each player in a market of the branded product, payer policies, and cost of production for the branded product;
calculating and recording the market share erosion rate of the branded product at a point of time after loss of exclusivity, by use of a dynamic half-life of a market value of the branded product at the point of time; and
producing recorded data including the market share erosion rate to a user for further use.

9. The computer program product of claim 8, the calculating the market share erosion rate comprising:
calculating and recording the market value at the point of time by reducing a first dynamic half-life of the market value estimated by a dynamic half-life formula to the market value by use of a conventional half-life formula t_{1/2}; and
calculating and recording the market share erosion rate as a ratio of respective lost market value over the initial market value cumulated up to the point of time as estimated on every time unit.

10. The computer program product of claim 9, wherein the first dynamic half-life is adjusted, upon an occurrence of an event at one point of time, based on a dynamic half-life at a previous point of time and a combination of a type of the event, a probability for a generic product entering the market of the branded product, and a type of the branded product, such that the dynamic half-life accurately reflects influence of the event for the type of the branded product on changes of the market value.

11. The computer program product of claim 10, wherein components of the dynamic half-life including the type of the event, the probability for the generic product entering the market of the branded product, and the type of the branded product, are multiplied by respective parameters estimated by use of auto-regressive modeling.

12. The computer program product of claim 11, wherein the event and corresponding type of the event is predicted based on the input data and historic data of the market.

13. The computer program product of claim 12, wherein the probability for the generic product entering the market of the branded product is estimated by use of an optimal water filling level for all products in a portfolio to which the branded product belong, the cost of production for the branded product from the input date, and a market potential of the market of the branded product.

14. The computer program product of claim 13, wherein the market potential is estimated by use of the financial data from the input data, and wherein the optimal water filling level is determined as a threshold for profitability in producing a product from the portfolio with a market condition as provided in the input data.

15. A system comprising:
a memory;
one or more processor in communication with memory; and
program instructions executable by the one or more processor via the memory to perform a method for predicting a market share erosion rate of a branded product after loss of exclusivity, comprising:
obtaining, by the one or more processor, input data including respective financial data of each player in a market of the branded product, payer policies, and cost of production for the branded product;
calculating and recording the market share erosion rate of the branded product at a point of time after loss of exclusivity, by use of a dynamic half-life of a market value of the branded product at the point of time; and
producing recorded data including the market share erosion rate to a user for further use.

16. The system of claim 15, the calculating the market share erosion rate comprising:
calculating and recording the market value at the point of time by reducing a first dynamic half-life of the market value estimated by a dynamic half-life formula to the market value by use of a conventional half-life formula t_{1/2}; and
calculating and recording the market share erosion rate as a ratio of respective lost market value over the initial market value cumulated up to the point of time as estimated on every time unit.

17. The system of claim 16, wherein the first dynamic half-life is adjusted, upon an occurrence of an event at one point of time, based on a dynamic half-life at a previous point of time and a combination of a type of the event, a probability for a generic product entering the market of the branded product, and a type of the branded product, such that the dynamic half-life accurately reflects influence of the event for the type of the branded product on changes of the market value.

18. The system of claim 17, wherein components of the dynamic half-life including the type of the event, the probability for the generic product entering the market of the branded product, and the type of the branded product are multiplied by respective parameters estimated by use of auto-regressive modeling.

19. The system of claim 18, wherein the event and corresponding type of the event is predicted based on the input data and historic data of the market.

20. The system of claim 19, wherein the probability for the generic product entering the market of the branded product is estimated by use of an optimal water filling level for all products in a portfolio to which the branded product belong, the cost of production for the branded product from the input date, and a market potential of the market of the branded product, and wherein the market potential is estimated by use of the financial data from the input data, and wherein the optimal water filling level is determined as a threshold for profitability in producing a product from the portfolio with a market condition as provided in the input data.
